(19) United States
(12) Patent Application Publication
(10) Pub. No.: US 2025/0233363 A1
(43) Pub. Date: Jul. 17, 2025

(54) CONNECTING DEVICE WITH REVERSE POLARITY PROTECTION

(71) Applicant: Pepperl+Fuchs SE, Mannheim (DE)

(72) Inventor: Frank Ebert, Mannheim (DE)

(73) Assignee: Pepperl+Fuchs SE, Mannheim (DE)

(21) Appl. No.: 19/009,347

(22) Filed: Jan. 3, 2025

(30) Foreign Application Priority Data
Jan. 16, 2024 (EP) 24152179.8

(51) Int. Cl. H01R 13/645; H01R 12/67; H01R 13/447

(52) U.S. Cl. CPC H01R 13/645; H01R 12/67; H01R 13/447

(57) ABSTRACT

A connecting device for providing an electrical connection with an AS-Interface cable having a shape-encoding protrusion includes a housing. At least one recess in the housing has a cross-section to accommodate the cross-section of the AS-Interface cable in at least two configurations. A protruding element laterally protrudes from one side of the recess to form accommodation spaces between the protruding element and the bottom of the recess and between the protruding element and the opening of the recess, respectively. The accommodation spaces are configured to accommodate the shape-encoding protrusion of the AS-Interface cable when fully inserted into the recess.

### TECHNICAL FIELD

The invention relates to a connecting device for a data transmission bus in a field data transmission system, wherein the connecting device is configured to accommodate a shape encoded flat data communication cable with multiple conductors to be connected with a predetermined polarity.

### TECHNICAL BACKGROUND

In the context of connecting shape-encoded data transmission cables, such as those conforming to the AS-Interface standard, to field I/O devices, a specialized connecting device is utilized. This device, either a standalone unit or integrated within the field I/O device, facilitates an electrical connection with the conductors of the data transmission cable. Field I/O devices may include e.g. binary ON/OFF devices such as actuators, sensors, rotary encoders, analog inputs and outputs, push buttons, and valve position sensors.

Field bus systems, utilized in automation applications like conveyor systems, packaging machinery, bottling lines, and food production lines, demand robust and installation-friendly data communication solutions between field I/O devices.

A typical configuration in such systems involves using a data communication cable compliant with the IEC 62026-2 standard for AS-Interface standard cables (Actuator Sensor Interface). The AS-Interface cable is a flat cable having two parallel conductors encapsulated in an insulation. This insulation has a distinct, asymmetrically shaped cross-section, featuring a unique, axially extending protrusion that extends along the cable's length. This specific design prevents incorrect polarity connections by ensuring the cable can only be connected in one orientation.

The connecting device enables the establishment of an electrical connection between the AS-Interface cable's conductors and a field I/O device. It incorporates two sharp pins that penetrate the cable's insulation during installation, thus creating an electrical connection between the field I/O device and the conductors of the AS-Interface cable.

The connecting device has a recess which substantially has a cross-sectional shape corresponding to the shape of the cross-section of the AS-Interface cable. This design ensures that the AS-Interface cable can only be inserted with an orientation that guarantees the conductors to be electrically connected by the pins with a correct polarity and to block an insertion of the AS-Interface cable in a wrong orientation. The shape encoding by the protrusion thus prevents the AS-Interface cable to being inserted into the recess of the connecting device, whereby a reverse polarity protection is established.

During installation, the orientation of both the connecting device and the AS-Interface cable may necessitate looping the cable around the connecting device before insertion, to ensure correct alignment. In essence, the manner in which the connecting device is positioned dictates whether the AS-Interface cable can be directly slotted into the recess or if reorientation of the cable, by looping, is necessary for proper connection.

Document DE202012103212U1 discloses a connection device for a data transmission bus, the device serving for connection to one or more shape-coded flat cables with an axial distinctive feature, having a base which is provided with at least one recess, and having a housing which is removably fastened to the base, and contact pins are provided which permit the connection to conductors of the at least one cable, which is accommodated in the at least one recess. The base comprises at least one recess, and a coding feature which is adjustable in the height of the recess is placed along at least a partial length of a side wall of the recess, so that the coding feature has a shape which is complementary to the shape of the flat cable.

It is therefore an object of the present invention to provide a connecting device for connecting an AS-Interface cable maintaining a reverse polarity protection and avoiding that the orientation of the cable has to be altered by cumbersome looping or folding during installation.

### SUMMARY OF THE INVENTION

This object has been achieved by the connecting device having a shape of the cross-section of the recess to accommodate an AS-Interface cable according to claim 1 and an arrangement of the connecting device with an inserted AS-Interface cable according to a further independent claim.

Further embodiments are specified in the depending subclaims.

According to a first aspect, a connecting device for providing an electrical connection with an AS-Interface standard cable having a shape-encoding protrusion is provided, comprising:
a housing;
at least one recess in the housing having a cross-section to accommodate the cross-section of the AS-Interface cable in at least two configurations, i.e. orientations;
a protruding element laterally protruding from one side of the recess to form accommodation spaces between the protruding element and the bottom of the recess and between the protruding element and the opening of the recess, respectively, wherein the accommodation spaces are configured to accommodate the shape-encoding protrusion of the AS-Interface cable when fully inserted into the recess.

According to European standard EN 62026-2, an AS-Interface cable which is used for data transmission in an AS-Interface system has an asymmetric cross-section with a protrusion. The AS-Interface cable has two parallel conducting wires which are embedded in an insulating material, e.g., a flexible polymer or elastomer. To distinguish the polarity of the two conductors, the insulating material has a protrusion protruding into a first direction which is a direction of the parallel arrangement of the two conductors perpendicular to the axial direction being the length dimension of the cable. A second direction is defined as being perpendicular to the first direction and perpendicular to the axial direction. With respect to the first direction, the insulation has two opposing first edges limiting the extension of the AS-Interface cable along the first direction. With respect to the second direction the insulation has two opposing second edges limiting the extension of the AS-Interface cable along the second direction. The protrusion is formed in an area between a middle axis being halfway between the two opposing second edges and one of the opposing second edges of the AS-Interface cable, thereby proving an asymmetry regarding the first and second direction.

Basically, according to the standard, the two opposing second edges of the cross-section of AS-Interface cable are in parallel while the one second edge which is closer to the protrusion is longer than the other second edge. Furthermore, one of the two opposing first edges of the cross-section of AS-Interface cable is tilted, while the other of the two opposing first edges of the cross-section of AS-Interface cable has two tilted sections.

The protrusion which is formed on the other one of the two opposing first edges prolongs the one second edge side by a portion of the total width along the first direction.

The shape encoding protrusion extends along the full length dimension of the AS-Interface cable, giving the cable a relatively large curvature bending radius. Conventional connecting devices for providing interfaces with field I/O devices to be electrically connected with the AS-Interface cable allow insertion of the AS-Interface cable in exactly one configuration, i.e. orientation, to avoid a wrong polarity connection. This might require looping or folding the AS-Interface cable around the connecting device to bring the profile of the AS-Interface cable into the correct configuration, i.e. orientation, for insertion into the at least one recess in the connecting device having a complementary cross-sectional shape.

The above connecting device has a structure which allows the AS-Interface cable to be inserted in two configuration, i.e. orientations, defined by flipping the cable around the first direction by 180°. This avoids the need to loop the AS-Interface cable around the connecting device in case the orientation is wrong with respect to the first direction. A reverse polarization is prevented by mechanically blocking the AS-Interface cable to being inserted into the recess when it has a wrong orientation with respect to the second direction, i.e. the protrusion directs to a side where there is no corresponding space in the recess of the connecting device.

The recess in the connecting device has a cross-section which has on one side (side wall) a protruding element protruding into the recess in a lateral direction. The protruding element is located at the portion of the recess which corresponds to the protrusion of the AS-Interface cable. The protruding element extends in the lateral direction, which corresponds to the first direction of the AS-Interface cable when inserted. The protruding element has a protrusion length not longer than the protrusion of the AS-Interface cable to be inserted.

It may be provided that the protruding element is located at a position at a side wall of the recess which is halfway with respect to the depth of the recess, so that the accommodation spaces have equal sizes. So, two accommodation spaces for the shape-encoding protrusion of the AS-Interface cable are formed, one accommodation space between the protruding element and the bottom of the recess and one between the protruding element and the opening of the recess on a surface of the connecting device.

The purpose of the protrusion element is to block an insertion of the AS-Interface cable as long as the AS-Interface cable is tried to be inserted with the protrusion on a side of the recess which is opposite to the protruding element.

If an insertion of the AS-Interface cable is made with the shape encoding protrusion on the side of the recess which has the protruding element, the AS-Interface cable can be inserted in two configurations. In the first configuration, the shape encoding protrusion is inserted in the accommodation space formed between the protruding element and the bottom of the recess. In the second configuration, the shape encoding protrusion is accommodated in the accommodation space formed by the protruding element and the opening of the recess.

To insert the AS-Interface cable into the connecting device according to the first configuration, the AS-Interface cable has to be slightly twisted or turned or tilted around the axial direction so that the shape encoding protrusion enters the recess first. The protrusion is then moved along the bottom of the recess towards the accommodation space until fully accommodated. At least the AS-Interface cable is twisted or turned or tilted to accommodate the rest of the cross-section into the recess.

To insert the AS-Interface cable into the connecting device for the second configuration, the AS-Interface cable can be simply inserted without turning the cable around the axial direction.

It may be provided that the protruding element is wedge-shaped or has wedge-shaped cross-section, which leads to a deformation of the shape encoding protrusion of the AS-Interface cable upon insertion into the recess. This is possible as the insulating material has a flexibility. The wedge shape ensures a sufficient mechanical stability of the protruding element, which reduce flexibility against being bent toward the bottom or to the opening of the recess.

It may be provided that the bottom of the recess under the protruding element is lowered or sloped to the edge to form a deformation space to partly accommodate a deformed shape-encoding protrusion of the AS-Interface cable. When the AS-Interface cable is inserted for the first configuration, the deformable material of the shape encoding protrusion of the AS-Interface cable is slightly deformed. To provide space for deformation in the first configuration, the bottom of the recess below the protruding element may be lowered to allow accommodating a deformed part of the shape encoding protrusion.

Furthermore, the protruding element may comprise one or more pins or one or more fins at least partly extending along an axial direction of the recess.

It may be provided that the protruding element is made of a flexible or elastic material so that when the AS-Interface cable is fully accommodated in the at least one recess, the protruding element is bent by the shape encoding protrusion of the AS-Interface cable. This allows clamping the shape encoding protrusion in the accommodation space when inserted in the first configuration, which may facilitate the contacting process of the AS-Interface cable.

Furthermore, a cover may be provided configured to close the opening of the at least one recess after the AS-Interface cable is inserted therein, wherein contact needles or contact pins protruding from the cover towards the at least one recess are provided when the cover is moved to close the opening of the recess.

According to a further aspect, an arrangement is provided comprising the above connecting device and an AS-Interface cable, particularly conforming to the AS-Interface standard cable according to standard IEC 62026-2.

Moreover, the AS-Interface cable may be inserted into the recess so that the shape-encoding protrusion of the AS-Interface cable is accommodated in the accommodation space between the protruding element and the bottom of the recess.

Alternatively, the AS-Interface cable may be inserted into the recess so that the shape-encoding protrusion of the AS-Interface cable is accommodated in the accommodation space between the protruding element and the opening of the recess.

### BRIEF DESCRIPTION OF THE DRAWINGS

Embodiments are described in more detail in conjunction with the accompanying drawings, in which:

FIG. 1 a cross-sectional view of an AS-Interface cable along an axial direction;

FIG. 2 a cross-sectional view of the AS-Interface cable across the axial direction in multiple possible orientations A to D;

FIGS. 3a and 3b a top view and a cross-sectional view of a connecting device;

FIG. 4 shows a process of insertion of an AS-Interface cable in a first configuration into a recess of a connecting device;

FIG. 5 shows a process of insertion of an AS-Interface cable in a first configuration into a recess of a connecting device; and

FIG. 6 a cross-sectional view of the connecting element with a wedge-shaped protrusion element.

### DESCRIPTION OF EMBODIMENTS

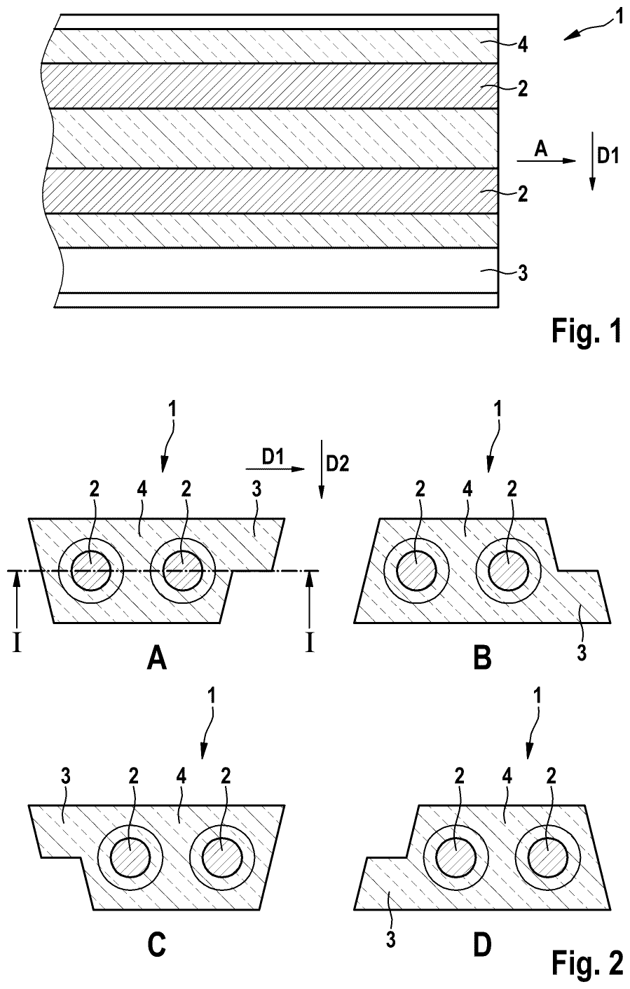

FIG. 1 shows a cross-sectional view of an AS-Interface cable 1 with two parallel conductors 2 extending along an axial direction A. Herein, it is referred to the AS-Interface standard cable according to standard IEC 62026-2:2008. The conductors 2 are arranged in a first direction D1. The conductors are encapsulated in an insulating material forming a main body 4 of the cable and a protrusion 3 extending in the first direction D1 from the main body 4.

FIG. 2 shows four possible orientations (labelled A-D) of the AS-Interface cable 1 in a cross-sectional view along the first direction D1 in. The main body 4 has a protrusion 3 that extends only from one half of the body with respect to a second direction D2, which is perpendicular to both the first direction D1 and the axial direction.

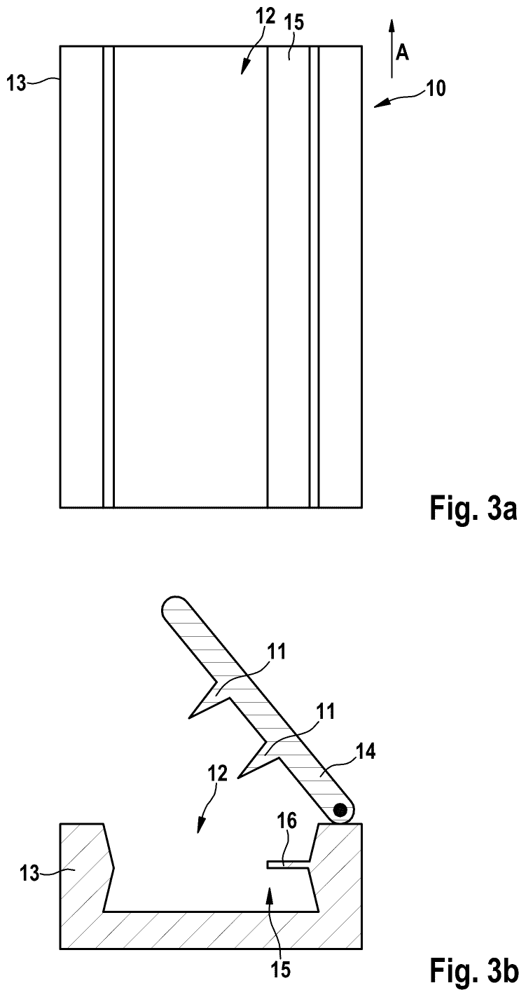

The AS-Interface cable 1 is to be inserted in a connecting device 10 as shown in the top view and the cross-sectional view of FIGS. 3a and 3b.

The connecting device 10 is provided with a housing 13 with a recess 12 forming a channel through the housing 13. The channel has open sides, allowing the AS-Interface cable 1 to be inserted into the recess 12. The housing has a cover 14 which is hinged at the housing 13 at one side of the channel which can be pivoted to close the opening of the recess 12. The cover 14 is provided with two contact pins or needles 11 protruding towards the opening of the recess 12. These pins 11 are arranged in such a way that when the AS-Interface cable 1 is inserted into the channel/recess 12 with a fitting orientation (i.e. the first or second configuration) and when the cover 14 is pivoted to close the opening of the recess 12, they pierce the insulating material of the inserted AS-Interface cable 1 and make an electrical contact with the conductors 2 therein. In other words, the AS-Interface cable 1 is contacted by contact needles or contact pins 11 located on a cover 14. The contact needles or contact pins 11 project from the cover 14 for piercing or penetrating the AS-Interface cable 1 to establish electrical contact with the conductors 2 in the AS-Interface cable 1.

In an alternative embodiment, the contact pins 11 may be inserted into the recess 12 from the bottom through through-holes thereof after the AS-Interface cable 1 has been inserted.

FIG. 2 shows the four possible orientations of the AS-Interface cable 1. Orientations A and D can be converted into each other by rotating the cable 180° around the axial direction A, which can be achieved by twisting. The same applies to orientations B and C.

A transfer between orientations A and B or C, or between orientations B and A or D, for example, a rotation about any axis perpendicular to the axial direction A, which is around the first or second direction, is necessary. Particularly, transferring orientation A to orientation B or C or orientation C to orientation A or D means turning the AS-Interface cable 1 around the connecting device 10 which may result in a cumbersome cable routing. To avoid the cable routing with loops, it is desirable to allow the cable orientation to be accommodated in the recess just by twisting the flat cable around its axial direction.

On one side of the channel, there is an extension space 15 which forms an accommodation space for accommodating the protrusion of the AS-Interface cable 1 during insertion.

The extension space 15 is separated by a protruding element 16 laterally protruding as a separator, which may be in the form of one or more pins or a fin partly or fully extending along the length of the channel. The protruding element 16 protrudes laterally and forms two accommodation spaces 15 provided to accommodate the shape encoding protrusion 3 of the AS-Interface cable 1 of two possible orientations of the AS-Interface cable 1.

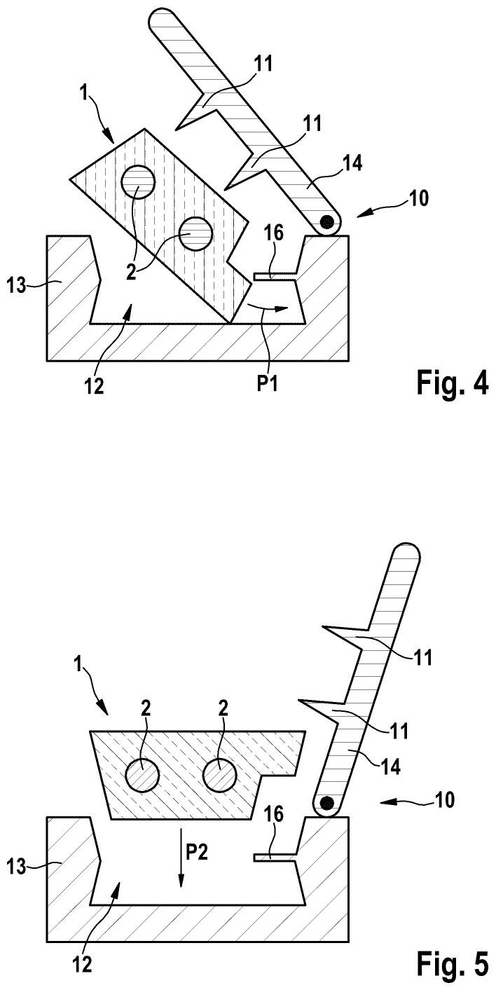

In a first configuration (first orientation), the shape encoding protrusion 3 of the AS-Interface cable 1 is being accommodated in the accommodation space 15 between the protruding element 16 and the bottom of the recess 12, as shown in FIG. 4. The insertion can be carried out by placing the shape encoding protrusion 3 into a space in the recess 12 which is close to the accommodation space 15 defined by the protruding element 16. Then the protrusion 3 is moved and turned towards the protrusion element 16 to bring the protrusion 3 of the AS-Interface cable 1 into the accommodation space to also insert the main body of the AS-Interface cable 1 into the recess 12. The movement of the AS-Interface cable 1 is illustrated by the arrow P1.

FIG. 5 shows the AS-Interface cable 1 in a second configuration (second orientation) being inserted into the recess 12. The AS-Interface cable 1 is pushed in a perpendicular direction into the recess 12 so that the protrusion 3 will be accommodated in the accommodation space 15 between the protruding element 16 and the opening of the recess 12. The movement of the AS-Interface cable 1 is illustrated by the arrow P2.

While in the second configuration/orientation, the AS-Interface cable 1 can be easily inserted into the channel in the vertical direction, the first configuration/orientation requires to push and to turn the AS-Interface cable 1 so that the shape encoding protrusion 3 will be shifted into the accommodation space below the protrusion element 16 until the opposite edge of the AS-Interface cable 1 can be pressed into the recess 12 so that the AS-Interface cable 1 is fully accommodated in the channel.

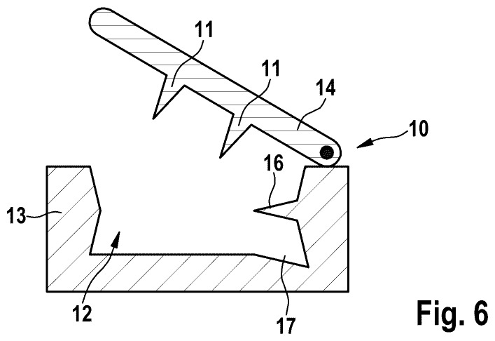

To provide a sufficient mechanical stability of the protrusion element 16, it may be provided with a wedge-shape, as shown in FIG. 6. This may result in when the AS-Interface cable 1 is inserted in the first configuration/orientation, the shape encoding protrusion 3 is deformed and bent downwards due to the insertion force. To accommodate the deformed material of the shape encoding protrusion 3, the bottom plane of the recess 12 may be lowered in the proximity of the accommodation space to create or to provide a deformation space 17 which enlarges the accommodation space at the bottom of the recess 12. Particularly, the deformation space 17 may provide a part of the bottom plane of the recess 12 which is substantially in parallel to the lower side of the wedge-shaped protrusion element 16.

1. A connecting device for providing an electrical connection with an AS-Interface cable having a shape-encoding protrusion, comprising:
a housing;
at least one recess in the housing having a cross-section to accommodate the cross-section of the AS-Interface cable in at least two configurations; and
a protruding element laterally protruding from one side of the recess to form accommodation spaces between the protruding element and the bottom of the recess and between the protruding element and the opening of the recess, respectively, wherein the accommodation spaces are configured to accommodate the shape-encoding protrusion of the AS-Interface cable when fully inserted into the recess.

2. The connecting device according to claim 1, wherein the protruding element is located at a fixed position at a side wall of the recess which is halfway with respect to the depth of the recess, so that the accommodation spaces have equal sizes.

3. The connecting device according to claim 1, wherein the protruding element is wedge-shaped, which deforms the shape encoding protrusion of the AS-Interface cable upon insertion into the recess.

4. The connecting device according to claim 3, wherein the bottom of the recess under the protruding element is lowered to form a deformation space to partly accommodate a deformed shape-encoding protrusion of the AS-Interface cable.

5. The connecting device according to claim 1, wherein the protruding element comprises one or more pins or one or more fins at least partly extending along an axial direction of the recess.

6. The connecting device according to claim 1, wherein the protruding element is made of a flexible material so that when the AS-Interface cable is fully accommodated in the recess the protruding element is bent by the shape encoding protrusion of the AS-Interface cable.

7. The connecting device according to claim 1, wherein a cover is provided configured to close the opening of the at least one recess after the AS-Interface cable is inserted therein, wherein contact needles or contact pins protruding from the cover towards the at least one recess are provided when the cover is moved to close the opening of the recess.

8. An arrangement comprising a connecting device according to claim 1 and an AS-Interface cable, particularly an AS-Interface standard cable conforming to standard IEC 62026-2.

9. The arrangement of claim 8, wherein the AS-Interface cable is inserted into the recess so that the shape-encoding protrusion of the AS-Interface cable is accommodated in the accommodation space between the protruding element and the bottom of the recess.

10. The arrangement of claim 8, wherein the AS-Interface cable is inserted into the recess so that the shape-encoding protrusion of the AS-Interface cable is accommodated in the accommodation space between the protruding element and the opening of the recess.
